(19) United States
(12) Patent Application Publication
(10) Pub. No.: US 2011/0067739 A1
(43) Pub. Date: Mar. 24, 2011

(54) Multi-functional foldable frame

(76) Inventor: Ching-Hsiu Ma, Tai Pao City (TW)

(21) Appl. No.: 12/585,712

(22) Filed: Sep. 23, 2009

(51) Int. Cl. A47C 13/00; A47B 85/00; A61H 3/00; A47K 13/00

(52) U.S. Cl. 135/66; 297/5; 211/2; 4/237

(57) ABSTRACT

A multi-functional foldable frame is revealed. The multi-functional foldable frame includes two C-shaped frames, two H-shaped frames, and a flat rack. By the H-shaped frame pivoted to and located with each vertical segment of the two C-shaped frames and a demountable horizontal tube part of the other H-shaped frame, the frame is folded inward around an axis respectively located on a connection between the two C-shaped frames and the H-shaped frame. Thus the volume of the frame after being folded is reduced and this is beneficial to easy carrying and transportation. Moreover, the frame is applied to bath chairs, chamber pots, walking aids, shelves and so on.

### BACKGROUND OF THE INVENTION

1. Fields of the Invention

The present invention relates to a multi-functional foldable frame that is folded for reducing space occupied and easy transportation and carrying while not in use. Moreover, the foldable frame is applied to bath chairs, chamber pots, walking aids, shelves, etc.

2. Descriptions of Related Art

Refer to Taiwanese Pat. No. M278397, a frame of bath chairs or chamber pots mainly consists of two supports, a rear rack and a base rack. The two supports are C-shaped and grab bars are disposed thereabove. As to the rear rack, it is also C-shaped and the two ends of the rear rack are pivoted to a rear side of each support by a connection member. The base rack is fixed between the two supports, near a center therebetween.

However, the design of this frame is unable to be folded because the racks are connected with each other fixed and firmly. Thus when the chamber pots or the bath chairs are not in use, the space around is occupied. For frame manufacturers, such design requires certain space for transportation and storage so that the cost of transportation and storage is usually quite high.

Moreover, refer to Taiwanese Pat. No. M315576,a walking aid includes two legs, an upper connection rod, and a lower connection rod. Grab bars and connection holes are disposed over the two legs and a button is arranged at a front rod part. Two ends of the upper connection rod are disposed with connection parts and the connection parts are mounted with long slots. By connection elements inserting through the connection holes, slots, the upper connection rod is assembled with the two legs. Moreover, the lower connection rod is disposed with a sleeve on two sides respectively so as to connect with the front rod part of two legs. The sleeve is arranged with at least one location hole that restricts movement of the two legs and at least one slot hole that allows a shift of the two legs at different heights. By the adjustable connection of the location hole and the slot hole with the button, the two legs are movable. Thus the walking aid can be adjusted and switched between two modes-fixed type and swing type.

However, although such design provides two modes for users, the requirement of certain space during carrying, transportation, and storage or the space occupied while not in use is still a problem. Moreover, the frame is only suitable for walking aid, unable to be used in other ways. This shows a lack of practical significance.

### SUMMARY OF THE INVENTION

Therefore it is a primary object of the present invention to provide a foldable frame that is folded into a compact form with minimum volume while not in use so as to reduce the space occupied for easy storage, carrying and transportation.

In order to achieve above objects, a multi-functional foldable frame according to the present invention includes two C-shaped frames, two H-shaped frames, and a flat rack. A first stop member is disposed on a vertical segment of one of the two C-shaped frames and a horizontal slot is set on two vertical tube parts of the H-shaped frame for mounting the corresponding first stop member. Two vertical tube parts of the other H-shaped frame are fixed on the other vertical segment of each C-shaped frame. A connection part facing inwards is disposed on two vertical tube parts of the other H-shaped frame so as to connect with two ends of a horizontal tube part movably. One end of the flat rack is pivoted to the horizontal tube part of the H-shaped frame while the other end thereof is crossed over and arranged at the horizontal tube part of the other H-shaped frame so that the flat rack lies horizontally between the horizontal tube parts of the two H-shaped frames. When the two ends of the horizontal tube part of the other H-shaped frame are fixed between the two vertical tube parts that are respectively connected with each C-shaped frame, the two C-shaped frames and the two H-shaped frames are fixed in an extended state. When the horizontal tube part of the other H-shaped frame is disassembled with the connection parts of the two vertical tube parts and the flat rack is lifted, the first stop member moves inside the horizontal slot so that the two C-shaped frames are folded inward around an axis respectively located on a connection between the vertical segment and the vertical tube parts on two sides of the H-shaped frame. After being folded, the volume of the frame is reduced and this is convenient for easy carrying and transportation.

The first stop member is mounted inside the vertical segment of the C-shaped frame and is having a bent elastic part and a locking part that is on one end of the first stop member and is extending out of a wall of the vertical segment.

The two ends of the horizontal tube part of the H-shaped frame are arranged with a locking member respectively while the connection parts of two vertical tube parts are disposed with a locking hole respectively. By the locking member locked with and mounted into the locking hole, the two ends of the horizontal tube part are connected and fixed between the two vertical tube parts.

The locking member is disposed in the horizontal tube part and is including a bent elastic part as well as a locking part that is on one end of the locking member and is extending out of a wall of the horizontal tube part.

A C-shaped pivot part is disposed on one end of the flat rack so as to mount the horizontal tube part of one of the H-shaped frames. The pivot part is further arranged with a long hole and the horizontal tube part of one of the H-shaped frame is disposed with a second stop member, corresponding to and projecting into the long hole. Thus the flat rack is lifted rotatably within a certain length of the long hole. The other end of the flat rack is an arched connection part that leans against the horizontal tube part of the other H-shaped frame so that the flat rack is fixed on the horizontal tube parts of the two H-shaped frames horizontally. Once the user wants to fold the frame, the flat rack is lifted and is released from the horizontal tube parts of the two H-shaped frames.

The frame of the present invention further includes a cover plate that is pivoted to the position where the flat rack is pivoted to the horizontal tube part of one of the H-shaped frames. One side of the cover plate is fastened on a pivot sleeve with a C-shaped holding part. The diameter of an opening of the holding part is smaller than an outer diameter of the horizontal tube part. When the pivot sleeve is clamping the horizontal tube part of the H-shaped frame by the holding part, the cover plate is pivoted to the horizontal tube part of the H-shaped frame.

Moreover, a stopper is arranged at the horizontal tube part of the H-shaped frame so as to restrict the angle between the lifted cover plate and the horizontal tube part.

The frame of the present invention further includes an adjustment sleeve that is connected with the bottom of each vertical segment of each C-shaped frame movably so as to adjust the height thereof. A fastening member is mounted in the lower part of the vertical segment. Moreover, the fastening member is having a bent elastic part and a locking part that is disposed on one end of the fastening member and is projecting out of a wall of the vertical segment. The adjustment sleeve is set with a plurality of adjustment holes so as to lock with the locking part correspondingly for fixing the height of the frame after adjustment.

The frame can be applied to bath chairs, chamber pots, walking aids and shelves and the flat rack can be designed into different shapes such as a circle, a flat plate or a net, depending on its application.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an explosive view of an embodiment of a frame applied to commode chairs according to the present invention;

FIG. 2 is a perspective view of the embodiment applied to commode chairs according to the present invention;

FIG. 3 is a partial cross sectional view of the embodiment applied to commode chairs according to the present invention;

FIG. 4 is an assembled top view of an embodiment of a frame according to the present invention;

FIG. 5 is a schematic drawing showing an embodiment of a frame being lifted according to the present invention;

FIG. 6 is a top view of an embodiment of a frame being folded according to the present invention;

FIG. 7 is a schematic drawing showing an embodiment of a frame disposed with a cover plate according to the present invention;

FIG. 8 is a schematic drawing showing an adjustment sleeve assembled on a bottom of a vertical segment of a C-shaped frame according to the present invention;

FIG. 9 is a schematic drawing showing adjustment of the adjustment sleeve;

FIG. 10 is a perspective view of an embodiment of a frame applied to walking aids or bath chairs according to the present invention.

### DETAILED DESCRIPTION OF THE PREFERRED EMBODIMENT

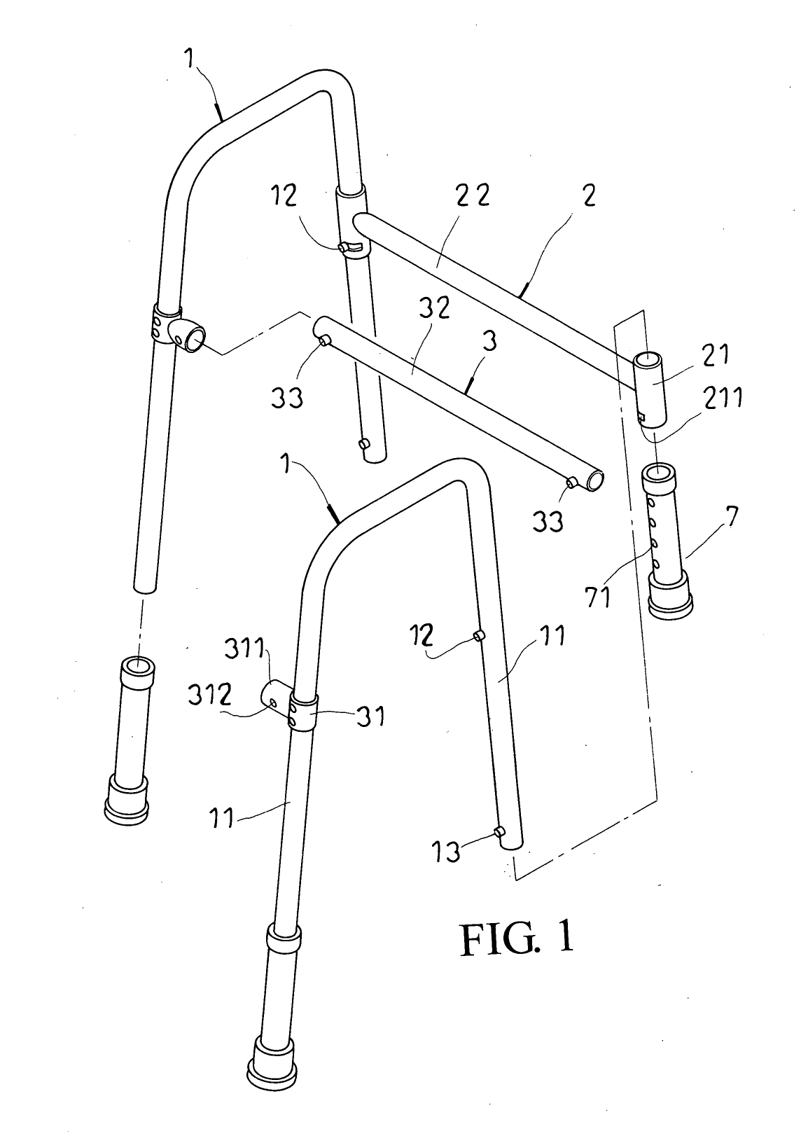

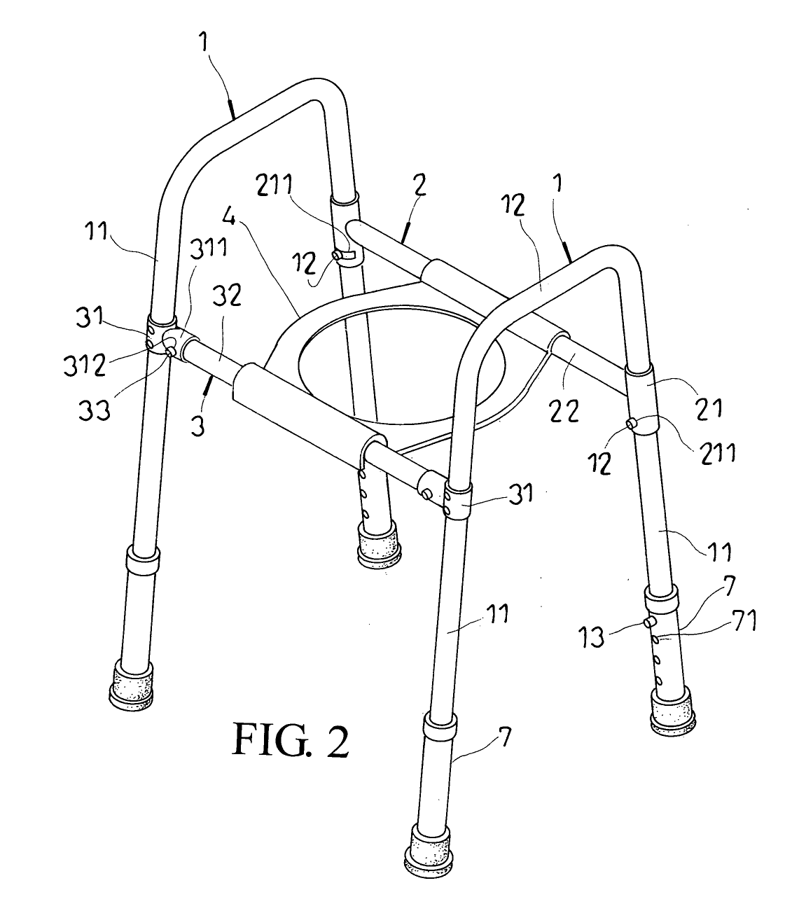

Refer to FIG. 1 and FIG. 2, a multi-functional foldable frame according to the present invention includes two C-shaped frames 1, two H-shaped frames 2, 3, and one flat rack 4. A first stop member 12 is disposed on a vertical segment 11 of one of the two C-shaped frames 1. Vertical tube parts 21, 31 are respectively arranged at two ends of each H-shaped frames 2, 3 for insertion of and connection with the vertical segment 11 of the C-shaped frame 1. A horizontal slot 211 is set on two vertical tube parts 21 of the H-shaped frame 2 for mounting the corresponding first stop member 12. Moreover, a connection part 311 facing inwards is disposed on two vertical tube parts 31 of the other H-shaped frame 3 so as to connect with two ends of a horizontal tube part 32 movably. The two ends of the horizontal tube part 32 are arranged with a locking member 33 respectively while the connection parts 311 of two vertical tube parts 31 are disposed with a locking hole 312 respectively. By the locking member 33 mounted in the locking hole 312, the two ends of the horizontal tube part 32 are connected and fixed between the two vertical tube parts 31. One end of the flat rack 4 is pivoted to a horizontal tube part 22 of the H-shaped frame 2 while the other end thereof is crossed over and arranged at the horizontal tube part 32 of the other H-shaped frame 3. Thus the flat rack 4 lies horizontally between the horizontal tube parts, 22, 32 of the H-shaped frames 2, 3.

When the two ends of the horizontal tube part 32 of the other H-shaped frame 3 are fixed between the two vertical tube parts 31 that are respectively connected with one vertical segment 11 of one of the two C-shaped frames 1, the two C-shaped frames 1 and the two H-shaped frames 2, 3 are fixed in a extended state.

By pressing the locking member 33 on the horizontal tube part 32 of the H-shaped frame 3 for releasing the locking member 33 from the locking hole 312 of the vertical tube part 31, the horizontal tube part 32 of the H-shaped frame 3 is disassembled with the connection parts 311 of the two vertical tube parts 31. Then the flat rack 4 is lifted and the first stop member 12 moves inside the horizontal slot 211 so that the two C-shaped frames 1 are folded inward around an axis respectively located on a connection between the vertical segment 11 and the vertical tube parts 21 on two sides of the H-shaped frame 2. The volume of the folded frame is reduced and this is beneficial to transportation and carrying.

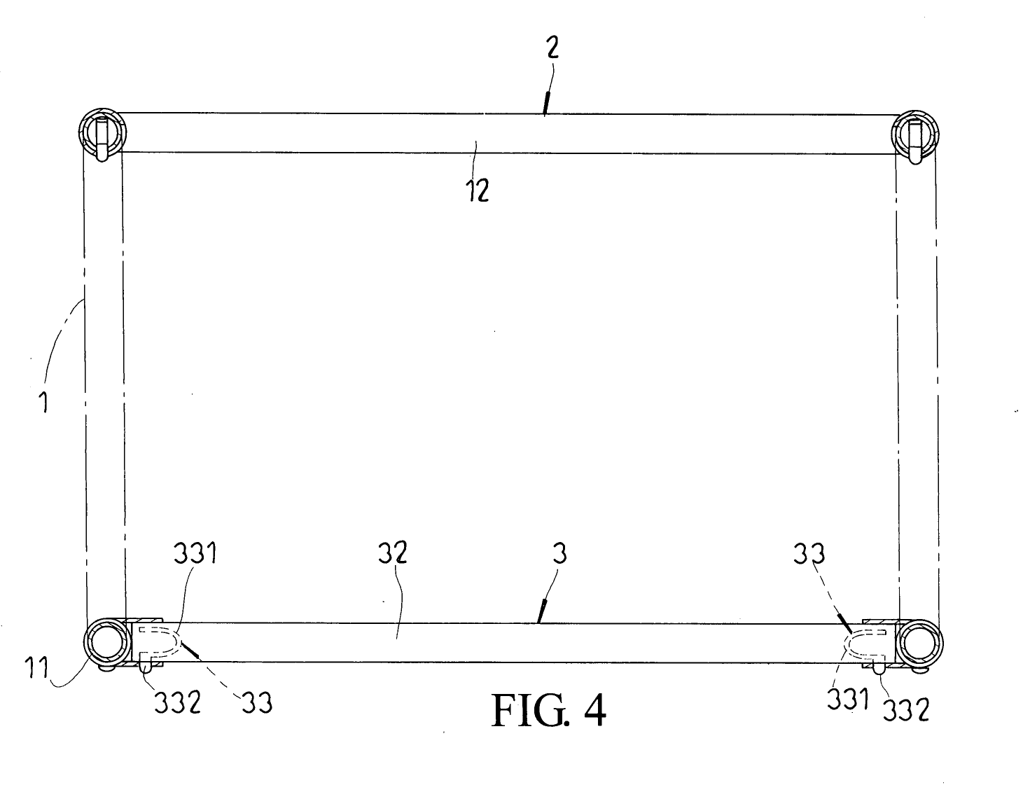

Refer to FIG. 1 to FIG. 4, the first stop member 12 is mounted inside the vertical segment 11 of the C-shaped frame 1 and is having a bent elastic part 121 and a locking part 122 that is extending out of a wall of the vertical segment 11 and is on one end of the first stop member 12.

The locking member 33 is disposed in the horizontal tube part 32 and is including a bent elastic part 331 as well as a locking part 332 that is extending out of a wall of the horizontal tube part 32 and is on one end of the locking member 33.

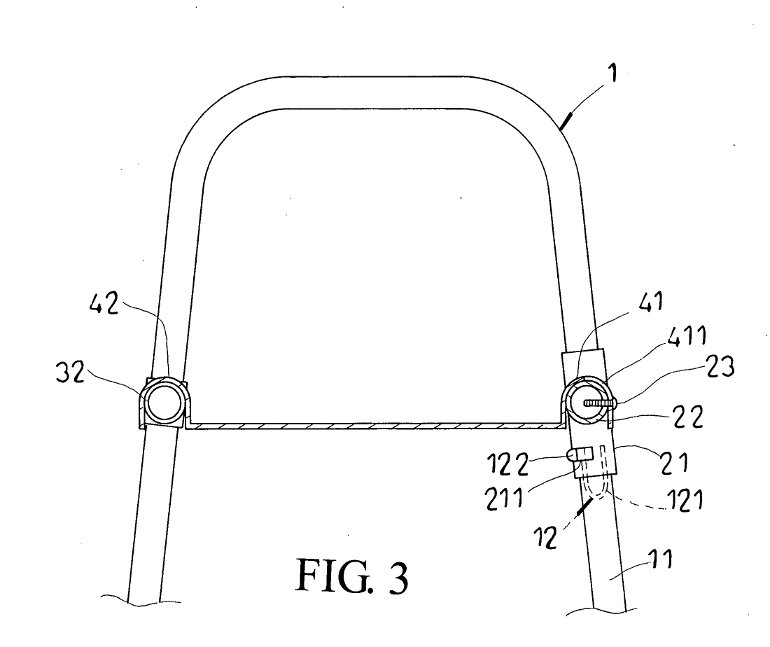

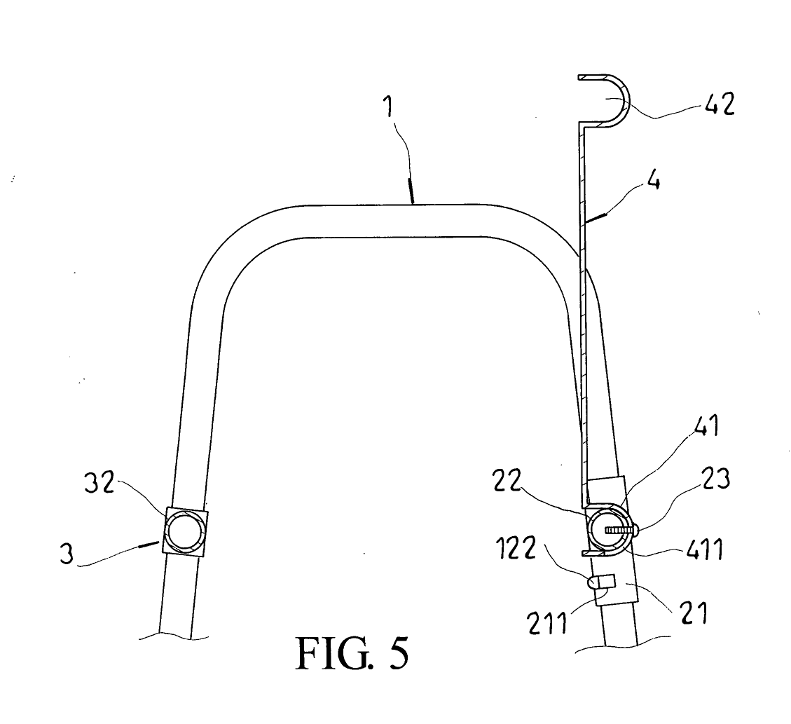

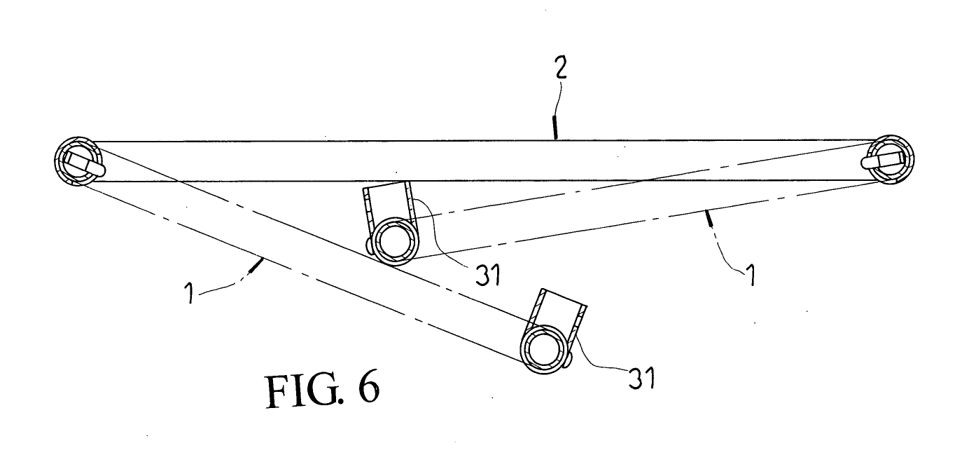

Refer to FIG. 3, FIG. 5 and FIG. 6, a pivot part 41 is arranged at one end of the flat rack 4 and the pivot part 41 is C-shaped so as to receive the horizontal tube part 22 of the H-shaped frame 2. The pivot part 41 is disposed with a long hole 411 and the horizontal tube part 22 of the H-shaped frame 2 is arranged with a second stop member 23, corresponding to and projecting into the long hole 411. Thus by the disposition of the second stop member 23 and the long hole 411, the flat rack 4 can be moved rotatably within a certain length of the long hole 411. The other end of the flat rack 4 is an arched connection part 42 that rests against the horizontal tube part 32 of the other H-shaped frame 3. Thus the flat rack 4 is fixed on the horizontal tube parts 22, 32 of the two H-shaped frames 2, 3. Once the user intends to fold the frame, the flat rack 4 is lifted to be released from the horizontal tube parts 22, 32 of the two H-shaped frames 2, 3.

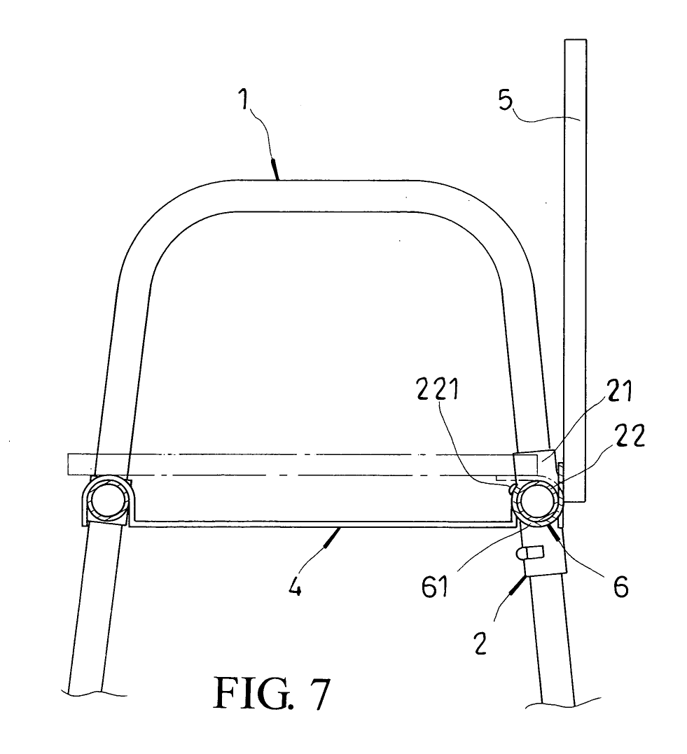

Refer to FIG. 7, a cover plate 5 is pivoted to the position where the flat rack 4 is pivoted to the horizontal tube part 22 of the H-shaped frame 2. One side of the cover plate 5 is fastened on a pivot sleeve 6 with a C-shaped holding part 61. The diameter of an opening of the holding part 61 is smaller than an outer diameter of the horizontal tube part 22. When the pivot sleeve 6 is assembled with the horizontal tube part 22 of the H-shaped frame 2 by the holding part 61, the cover plate 5 is also pivoted to the horizontal tube part 22 of the H-shaped frame 2.

Moreover, a stopper 221 is arranged at the horizontal tube part 22 of the H-shaped frame 2 so as to restrict the angle between the lifted cover plate 5 and the horizontal tube part 22.

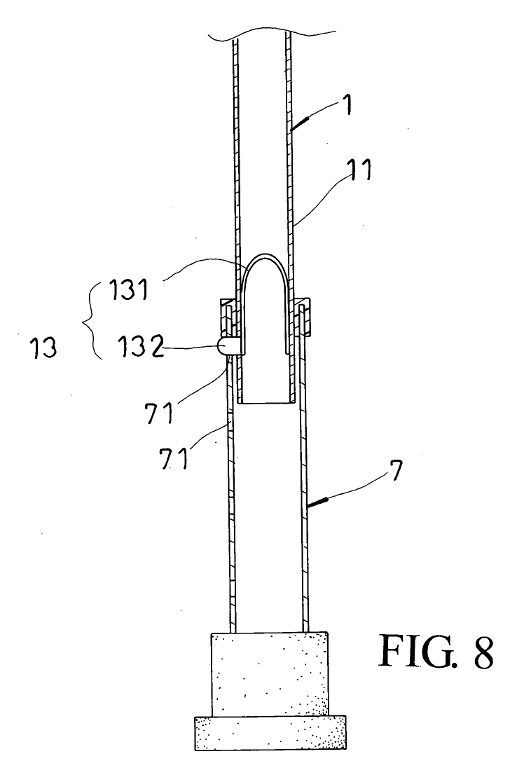

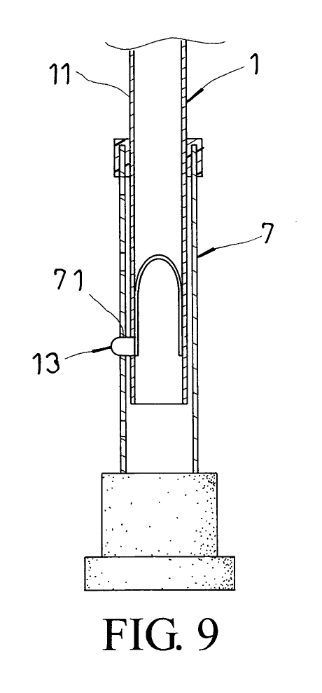

Furthermore, an adjustment sleeve 7 is connected with the bottom of each vertical segment 11 of each C-shaped frame 1 movably so as to adjust the height of the frame, as shown from FIG. 8 to FIG. 10. A fastening member 13 is mounted in the lower part of the vertical segment 11 and is having an elastic part 131 and a locking part 132 that is disposed on one end of the fastening member 13 and is projecting out of a wall of the vertical segment 11. The adjustment sleeve 7 is arranged with a plurality of adjustment holes 71 to lock with the locking part 132 correspondingly for fixing the height of the frame after adjustment.

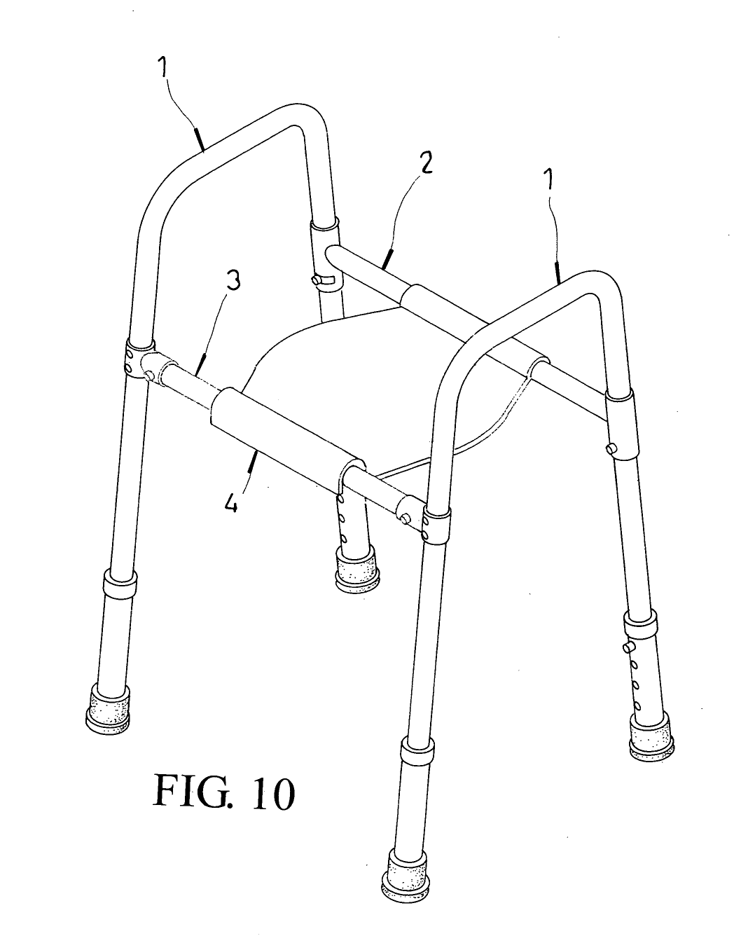

The frame can be applied to bath chairs, chamber pots, walking aids, shelves, etc. Due to various applications, the flat rack 4 is modified to different shapes such as a circle, a flat plate or a net, as shown in FIG. 1 and FIG. 10.

In summary, a frame of the present invention is foldable. Thus while not in use, the frame is folded into a state with minimum volume so as to reduce the occupied space of the frame for easy storage, carrying and transportation.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents

What is claimed is:

1. A multi-functional foldable frame comprising two C-shaped frames, two H-shaped frames, and a flat rack; wherein a first stop member is disposed on a vertical segment of one of the two C-shaped frames and a horizontal slot is set on two vertical tube parts of one of the H-shaped frame for mounting the first stop member correspondingly; two vertical tube parts of the other H-shaped frame are fixed on the other vertical segment of each C-shaped frame and two vertical tube parts of the other H-shaped frame are connected with two ends of a horizontal tube part movably; one end of the flat rack is pivoted to the horizontal tube part of one H-shaped frame while the other end thereof is crossed and fixed on the horizontal tube part of the other H-shaped frame so that the flat rack is arranged between the horizontal tube parts of the two H-shaped frames horizontally.

2. The device as claimed in claim 1, wherein the first stop member is mounted in the vertical segment of the C-shaped frame and is having a bent elastic part and a locking part that is on one end of the first stop member and is extending out of a wall of the vertical segment.

3. The device as claimed in claim 1, wherein a connection part is disposed on each vertical tube part of the other H-shaped frame so as to connect with the horizontal tube part.

4. The device as claimed in claim 3, wherein two ends of the horizontal tube part of the other H-shaped frame are arranged with a locking member respectively and the connection parts of the two vertical tube parts are disposed with a locking hole respectively so that the two ends of the horizontal tube part are connected and fixed between the two vertical tube parts by the locking member locked with and mounted into the locking hole.

5. The device as claimed in claim 4, wherein the locking member is disposed in the horizontal tube part and is including a bent elastic part as well as a locking part that is on one end of the locking member and is extending out of a wall of the horizontal tube part.

6. The device as claimed in claim 1, wherein a pivot part is disposed on one end of the flat rack so as to mount the horizontal tube part of one of the H-shaped frames and the pivot part is further arranged with a long hole while the horizontal tube part of one of the H-shaped frame is disposed with a second stop member that is corresponding to and projecting into the long hole so that the flat rack is lifted rotatably within a certain length of the long hole by arrangement of the second stop member as well as the long hole.

7. The device as claimed in claim 6, wherein the pivot part is C-shaped.

8. The device as claimed in claim 6, wherein a connection part is formed on the other end of the flat rack so as to make the flat rack lean against the horizontal tube part of the other H-shaped frame.

9. The device as claimed in claim 8, wherein the connection part is arched.

10. The device as claimed in claim 1, wherein a cover plate is pivoted to a position where the flat rack is pivoted to the horizontal tube part of one of the H-shaped frames.

11. The device as claimed in claim 10, wherein one side of the cover plate is fastened on a pivot sleeve with a C-shaped holding part while diameter of an opening of the holding part is smaller than an outer diameter of the horizontal tube part and the pivot sleeve is clamping and fixed on the horizontal tube part of the H-shaped frame by the holding part.

12. The device as claimed in claim 10, wherein a stopper is arranged at the horizontal tube part of the H-shaped frame so as to restrict an angle of the cover plate being lifted from the horizontal tube part.

13. The device as claimed in claim 1, wherein an adjustment sleeve is connected with a bottom of each vertical segment of the two C-shaped frames movably so as to adjust height thereof.

14. The device as claimed in claim 13, wherein a fastening member is mounted in a lower part of the vertical segment and the fastening member includes a bent elastic part and a locking part projecting out of a wall of the vertical segment and located on one end of the fastening member while the adjustment sleeve is set with a plurality of adjustment holes so as to lock with the locking part correspondingly for fixing height of the frame after adjustment.

15. The device as claimed in claim 1, wherein the multi-functional foldable frame is applied to bath chairs, chamber pots, walking aids or shelves.

16. The device as claimed in claim 15, wherein the flat rack is a circle, a flat plate or a net.
